(19) United States
(12) Patent Application Publication
(10) Pub. No.: US 2003/0008044 A1
(43) Pub. Date: Jan. 9, 2003

(54) Process for packaging beverages in unmodified polyethylene terephthalate containers

(75) Inventor: Patrick Lafleur, Noumea New Caledonia (FR)

Correspondence Address: LADAS & PARRY, 26 WEST 61ST STREET, NEW YORK, NY, 10023, US

(73) Assignee: LE FROID S.A.

(21) Appl. No.: 10/205,283

(22) Filed: Jul. 25, 2002

Related U.S. Application Data
(63) Continuation of application No. 09/367,470, filed on Sep. 22, 1999, now abandoned.
Application No. 09/367,470 is a 371 of international application No. PCT/FR98/02735, filed on Dec. 15, 1998.

(30) Foreign Application Priority Data
Dec. 15, 1997 (FR) 97/15862

(51) Int. Cl. A23B 4/00

(52) U.S. Cl. 426/397

(57) ABSTRACT

A process for packaging a beverage into polyethylene terephthalate containers, the process includes the steps of: a) pasteurizing the beverage; b) cooling the pasteurized beverage to a temperature between about 25° C. and 50° C.; c) providing an unmodified PET container and a cap for the container and sterilizing the container and container cap; d) filling the sterilized container with the cooled pasteurized beverage; e) capping the filled sterilized container with the sterilized cap; and f) further pasteurizing the filled capped container at a temperature between about 55° C. and 65° C. for a period between approximately 15 to 60 minutes.

This invention relates to a beverage packaging process and system. More precisely, the invention relates to a process for packaging beverages, which have been sterilised or pasteurised, into standard viscosity index, that is to say non-modified, polyethylene terephthalate (PET) containers.

This invention concerns a process for packaging a sterilised beverage in a resealable polyethylene terephthalate package.

Hitherto it has not been possible to package beverages hot from sterilisation or pasteurisation processes into unmodified polyethylene terephthalate containers because the heat from the beverage caused distortion of the containers. Such beverages have to be packaged in more expensive modified polyethylene terephthalate containers.

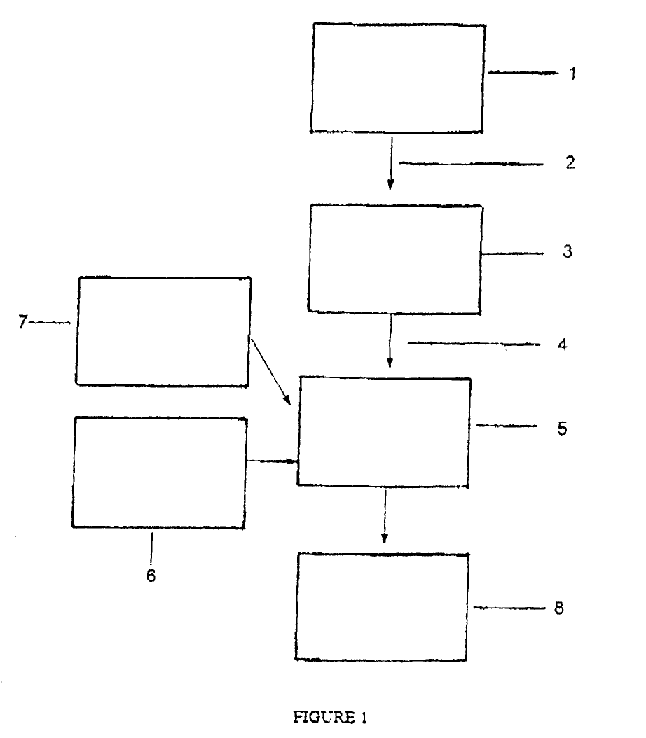

In the known processes which are illustrated in FIG. 1 and which the invention seeks to replace, a beverage 1 is manufactured and supplied via a conduit 2 to a pasteurisation unit 3. The beverage is pasteurised at 85° C. to 95° C. for 15 seconds to 45 seconds to achieve 50,000 pasteurisation units. The pasteurised beverage is transferred by the line 4 to a filler unit 5. Modified polyethylene terephthalate containers 6 and caps 7 are hot-filled at 85° C. and conveyed to the filler unit 5 where filling and sealing occur. The filled containers 8 are then allowed to cool to below 30° C.

The above-mentioned packaging arrangement for such beverages was designed for the use of special bottle designs and high heat-resistant polyethylene terephthalate resins which permit “hot filling” of a beverage into a polyethylene terephthalate container without the container suffering packaging defects or deformation. The unmodified polyethylene terephthalate containers cannot be used in this process.

However, this process of packaging beverages requires a special type of preform container and polyethylene terephthalate resin, which is approximately twice the cost of that of a standard polyethylene terephthalate resin preform container. Further, such a process required dedicated bottle blowing and moulding equipment, and a specifically-designed and dedicated filling machine.

However, a common disadvantage of the prior art process is that filling of polyethylene terephthalate containers with a pasteurised beverage involves temperatures which are generally in the range of 85° C. to 95° C., and the standard polyethylene terephthalate containers are unable to withstand the effects of liquids at this temperature. Therefore modified polyethylene terephthalate containers, which are able to withstand liquids with temperatures in the range of 85° C., have to be used.

As described above, the prior art process involves a dedicated process line and equipment for each beverage to be packaged. However, this invention has the advantage of permitting the use of the equipment and process line for different beverages. This feature represents a considerable cost saving, especially where the volume of production does not warrant the use of a process line for one particular beverage only.

The cost of a modified polyethylene terephthalate container is at least twice the cost of that of an equivalent unmodified polyethylene terephthalate container. Further, a standard polyethylene terephthalate container can be recycled, while a modified polyethylene terephthalate container, made from a resin which withstands liquids with temperatures in the range of 85° C. to 95° C., is not recyclable.

Therefore, there is a need for a process which permits filling of a standard polyethylene terephthalate container with a pasteurised beverage, that is to say it permits the use of standard, unmodified polyethylene terephthalate containers.

Surprisingly, according to the invention it has been found that, by incorporating chemical and/or radiation methods of sterilisation in the process of this invention, standard polyethylene terephthalate containers may be used as receptacles for pasteurised beverages.

Thus, in a first mode of implementation, the invention concerns a process for packaging beverages in unmodified polyethylene terephthalate containers which comprises:

a) pasteurising the beverage,

b) cooling the pasteurised beverage to a temperature below that at which the containers are deformed under the action of excessive heat,

c) sterilisation of the containers and caps,

d) filling of the sterilised receivers with cooled pasteurised beverage,

e) sealing the filled sterilised containers, and optionally

f) further pasteurisation of the filled and sealed container at a temperature below that at which the containers deform under the action of excessive heat.

The beverage is for example a still beverage.

The pasteurising step is performed for example at a temperature between approximately 50° C. and 100° C. Preferably the pasteurisation step is carried out a temperature between approximately 75° C. and 95° C. Even more advantageously, the pasteurisation step is carried out at a temperature between approximately 85° C. and 95° C.

For example, the pasteurisation step is performed for a period of between about 5 seconds and 1 minute. Preferably, the pasteurisation step is performed for a period of between about 10 seconds and 45 seconds. More advantageously, the pasteurisation step is performed for a period of between about 10 seconds and 30 seconds. Even more advantageously, the pasteurisation step is performed for a period of about 15 seconds.

For example, the beverage is cooled to a temperature between about 25° C. and 60° C. Preferably the pasteurised beverage is cooled to a temperature between approximately 25° C. and 50° C. More advantageously, the pasteurised beverage is cooled to a temperature between approximately 25° C. and 40° C. Even more advantageously, the pasteurised beverage is cooled to a temperature of about 35° C.

The polyethylene terephthalate container and/or the cap of the container can be sterilised generally by washing the polyethylene terephthalate container and/or the polyethylene terephthalate cap with an effective amount of a sterilising solution.

The polyethylene terephthalate container and/or the cap of the container are washed for example with a sterilising solution for a period of between approximately 10 seconds and 1 minute. Preferably, the polyethylene terephthalate container and/or the cap of the container are washed with a sterilising solution for a period of between approximately 15 seconds and 45 seconds. Even more advantageously, the polyethylene terephthalate container and/or the cap of the container are washed for example with a sterilising solution for a period of between approximately 25 seconds and 35 seconds. Most advantageously, the polyethylene terephthalate container and/or the cap of the container are washed with a sterilising solution for a period of approximately 30 seconds.

The sterilising solution may be, for example, peracetic acid or hydrogen peroxide. Preferably the sterilising solution is a solution of peracetic acid.

Furthermore, the peracetic acid solution has for example a pH adjusted to between approximately 2 and 4. Advantageously, the peracetic acid solution has a pH adjusted to between approximately 2 and 3. Even more advantageously, the peracetic acid solution has a pH adjusted to approximately 2.6.

For example, the peracetic acid solution is used at a concentration of between 50 and 250 ppm. More advantageously, the peracetic acid solution is used at a concentration of between 75 and 150 ppm. Even more advantageously, the peracetic acid solution is used at a concentration of 100 ppm.

In one variant of the invention, the polyethylene terephthalate container and/or the cap of the container may be sterilised by treating the polyethylene terephthalate container and/or the cap of the container with an effective amount of radiation. For example, the radiation may be ultraviolet radiation or ionising radiation such as gamma radiation or beta particle radiation.

For example, it is the container cap rather than the polyethylene terephthalate container which is sterilised by treatment with an effective amount of radiation, although there is nothing preventing the use of radiation for the sterilisation of the polyethylene terephthalate container.

Generally, the filled and sealed polyethylene terephthalate container is subjected to a secondary pasteurisation intended to eliminate any contamination which may occur between filling of the polyethylene terephthalate container with pasteurised beverage and the sealing of the filled polyethylene terephthalate container.

For example, the secondary pasteurisation is performed at a temperature of between 50° C. and 75° C. Preferably the secondary pasteurisation is performed at a temperature of between 55° C. and 65° C. Even more advantageously, the secondary pasteurisation is performed at a temperature of between 60° C. and 65° C.

For example, the secondary pasteurisation is performed for a period of between approximately 15 minutes and 60 minutes. Preferably the secondary pasteurisation is performed for a period of between approximately 20 minutes and 40 minutes. Even more advantageously, the secondary pasteurisation is performed for a period of between approximately 20 minutes and 30 minutes. Most preferably, the secondary pasteurisation is performed for a period of approximately 20 minutes.

Generally, the filled polyethylene terephthalate container exits the pasteuriser at about 35° C.

Other characteristics and advantages of the invention will better emerge from the description which will follow design examples, made with reference to the annexed drawings in which:

FIG. 1 shows a diagram illustrating the operations in a known filling process employing modified polyethylene terephthalate containers; and

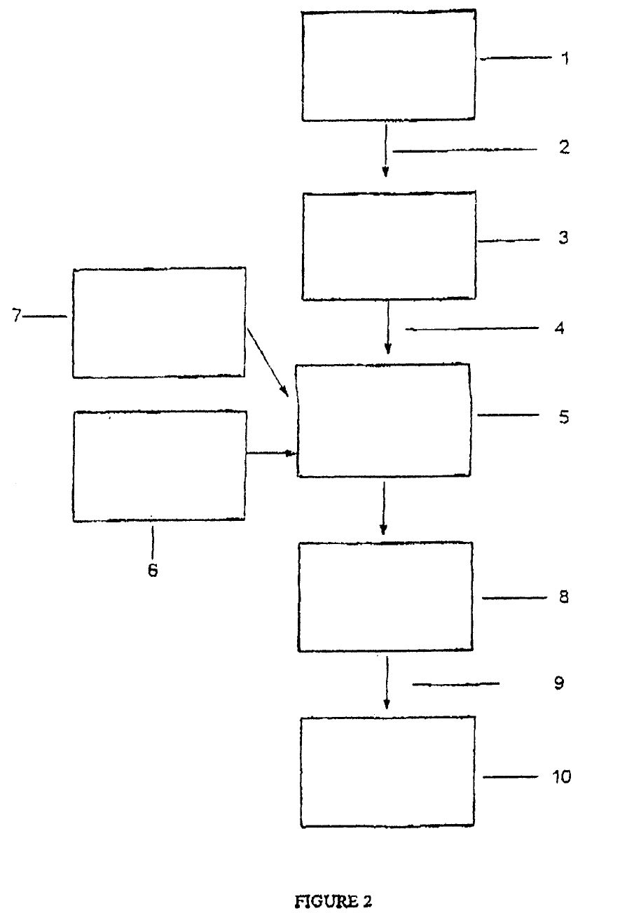

FIG. 2 shows a diagram illustrating the operations in a filling process according to the invention employing standard polyethylene terephthalate containers.

Using the process according to this invention, it is possible to use standard viscosity index polyethylene terephthalate resin preforms to manufacture bottles for both carbonated and still beverages. In addition, the process according to the invention does not require any dedicated bottle blowing or handling equipment.

The process according to the invention for packaging beverages, which have been sterilised or pasteurised, into standard polyethylene terephthalate containers, that is to say unmodified polyethylene terephthalate containers, is illustrated in FIG. 2. First, a beverage 1 is manufactured and supplied via a conduit 2 to a pasteurisation unit 3. The beverage is pasteurised at 85° C. and 95° C. for 15 seconds to 45 seconds to achieve 50,000 pasteurisation units. The pasteurised beverage may then be cooled to approximately 35° C. in the pasteuriser then it is transferred by the line 4 to a filler unit 5. The polyethylene terephthalate containers 6 and the caps 7 are conveyed to the filler unit 5 where fining and sealing are carried out. The filled and sealed containers 8 are conveyed by 9 to a tunnel pasteurisation station 10 and subjected to a secondary pasteurisation.

The polyethylene terephthalate containers used are made of standard 41.5 g polyethylene terephthalate preforms, such as “P041 Smorgon Plastic” (Smorgon Plastics, Wetherill Park, NSW, Austalia). The same polyethylene terephthalate preform can be used conventionally [sic], by using the standard polyethylene terephthalate container to manufacture other bottles for carbonated beverages in the same plant by simply changing the bottle mould on a moulding machine, for example “Sidel” (Groupe SIDEL, Bureau de Paris, Paris, France).

Sterilisation of the polyethylene terephthalate containers is achieved by washing the polyethylene terephthalate containers in a solution of peracetic acid having a pH of 2.6 at a concentration of 100 ppm, for about 30 seconds, using a conventional (360°) twist rinser. After washing with peracetic acid, the sterilied polyethylene terephthalate container may be rinsed by using a second 360° twist rinser using sterile water to remove any traces of peracetic acid from the container. The secondary washing treatment is particularly useful during the preparation of very sensitive flavoured beverage formulations.

The inside of the caps of the polyethylene terephthalate containers have been sterilised by treatment with ultraviolet light for a period of about 30 seconds. Sealing of the filled polyethylene terephthalate container is normally achieved in a time of less than 1 second per container.

The energy of radiation in the ultraviolet region of the spectrum is highly bactericidal especially at wavelengths of approximately 265 nm, and ultraviolet radiation in this region is useful for sterilising smooth surfaces.

As described above, forms of ionising radiation such as gamma rays and beta particles can also be used for sterilisation. Gamma rays are high-energy electromagnetic radiation similar to x-rays. They have a very high penetration capacity, and their energy is dissipated in the production of ionised particles from the material being irradiated. Radioactive isotopes, such as cobalt-60, constitute a common source of gamma rays and sterilisation requires a radiation dose of approximately 5,000,000 rad. The advantages of this method are that, unlike sterilisation by steam, it can be performed at low temperatures on plastics or other thermally unstable materials, and unlike other germicidal agents, ionising radiation can reach every point inside the treated product, Further, radiation-sterilised objects are not radioactive.

Beta particles are another form of ionising radiation which can be used for sterilising polyethylene terephthalate containers and/or caps of containers. Beta particle radiation has a relatively low penetration capacity, which depends on the energy level of the emitted electron beam. Beta particles sterilise in an identical manner to gamma rays and without significantly raising the temperature of the irradiated material.

Essentially, the beverage is sterilised in a flash pasteuriser, in which the specific conditions may vary depending on the type of beverage being sterilised. For the majority of still beverages, pasteurisation takes place at a temperature between 95° C. and 97° C. for 30 to 40 seconds (80,000 pasteurisation units). The beverage is then allowed to cool before exiting the heat exchanger system to the filler unit at a temperature of between 32° C. and 38° C. The cooled, pasteurised beverage is added to the sterilised polyethylene terephthalate containers.

The filing temperature has the following effects:

a) the container suffers practically no distortion,

b) the coefficient of contraction of the beverage is sufficient to provide a negative internal pressure in the container at the end of the process, and

c) the internal pressure of the container is sufficient to ensure that the container maintains its symmetry during further processing.

All of these characteristics have important consequences for labelling and conveying of the sterilised polyethylene terephthalate containers.

In the course of filling the sterilised polyethylene terephthalate containers, filling valves are adjusted so as to give container brim (flood) fill conditions. Depending on the type of auxiliary pressure filling device used, different adjustments are necessary to allow the filling of a non-carbonated beverage. “Sarcmi” fillers (Sarcmi SAR 40/10 1988 Sasib Beverage M.S., 43015, Noceto Parma, Italy) have a simple overflow system, but others may have to have back pressure of filtered air or nitrogen, rather than conventional carbon dioxide.

During the filling operation of the sterilised polyethylene terephthalate container with the pasteurised beverage, the polyethylene terephthalate container is shrouded in plastic to minimise recontamination.

The brim-filled (flood) containers are then sealed using a conventional carbonated beverage sealer and plastic cap compatible with the container neck, for example the ACI “Doublelock” or the Crown Cork & Seal “Polygard”. However, a “Monoblock” type cap is the most suitable. The inside caps are sterilised prior to application by an ultraviolet system, for example “Berson WHHSI” (Unimex, Bergamo, Italy) which is permanently mounted on the capper infeed conveyor. The transfer plate, along which the filled polyethylene terephthalate containers travel, is also decontaminated by a continuous misting of 100 ppm peracetic acid solution with a pH of 2.6, the design being such as to not contaminate the cap or filled bottle with the sterilising solution.

A filled and sealed polyethylene terephthalate container is normally date-coded then is subjected to a secondary mild tunnel pasteurisation at a temperature of 61° C. to 65° C. for 30 minutes (giving 100 to 300 pasteurisation units) to eliminate any contamination that may have been introduced during the transfer from the filling station to the capping station. Treating the filled polyethylene terephthalate containers at 65° C. for 30 minutes allows maximum heat tolerance of the polyethylene terephthalate container without distortion or package failure. The packaged product exits the tunnel pasteuriser at 35° C.

The packaged product is then conveyed (ideally via an accumulation table) to a conventional labeller and secondary packer and palletiser.

The invention will now be described in more detail by reference to a specific example which by no means limits its scope.

### EXAMPLE

A non-preservative 35% orange juice beverage is transferred to a pasteurisation unit. The beverage is subjected to flash pasteurisation at 96° C. to 97° C. for 36 seconds, giving 83,400 pasteurisation units, then it is allowed to cool to approximately 35° C., before being transferred to a filler unit. The polyethylene terephthalate containers are conveyed to a filler unit where filling and sealing occur. The filled and sealed containers are then conveyed to a tunnel pasteurisation station and subjected to a secondary pasteurisation at 65° C. for 30 minutes to achieve 100 pasteurisation units. The filled and sealed containers are then cooled to approximately 35° C. before exiting the tunnel pasteuriser.

The polyethylene terephthalate containers used are made of standard 41.5 g polyethylene terephthalate preforms, such as “P041 Smorgon Plastic” (Smorgon Plastics, Wetherill Park, NSW, Australia). Sterilisation of the polyethylene terephthalate containers is performed by washing the polyethylene terephthalate containers in a peracetic acid solution, with a pH of 2.6 and concentration of 100 ppm, for about 30 seconds using a conventional (360°) twist rinser. After washing with peracetic acid, the sterilised polyethylene terephthalate container may be rinsed by using a second 360° twist rinser using sterile water to remove any traces of peracetic acid from the container.

Both the inside and outside of the caps of the polyethylene terephthalate containers are sterilised by treatment with ultraviolet light for a period of about 5 to 15 seconds. Sealing of the filled polyethylene terephthalate container takes place in a period less than 5 seconds per container.

The packaged product is then conveyed (ideally via an accumulation table) to a conventional labeller and secondary packer and palletiser.

The beverage packaging and processing system according to this invention can be used for processing beverages, for example still beverages, which have been sterilised or pasteurised, and packaged into standard, unmodified polyethylene terephthalate containers.

It is obvious that the invention has been described and represented only by way of preferential example and that any technical equivalence in its component elements can be imparted without at all departing from its scope.

1. A process for packaging beverages into unmodified polyethylene terephthalate containers, characterised in that it comprises:
a) pasteurising (3) the beverage,
b) cooling the pasteurised beverage to a temperature below that at which the containers are deformed under the action of excessive heat,
c) sterilisation of the containers and caps,
d) filling of the sterilised receivers with cooled pasteurised beverage,
e) sealing the filled sterilised containers, and
f) further pasteurisation (10) of the filled and sealed container at a temperature below that at which the containers deform under the action of excessive heat.

2. A process according to claim 1, characterised in that the beverage is a still beverage.

3. A process according to either one of claims 1 and 2, characterized in that the pasteurisation step (a) is performed at a temperature in one of the following ranges: 50° C. to 100° C., 75° C. to 95° C., and 85° C. to 95° C.

4. A process according to any one of claims 1 to 3, characterised in that the pasteurisation step (a) is performed for a period selected from the following periods: a period of between 5 seconds and 1 minute, a period selected between 10 and 45 seconds, a period selected between 10 and 30 seconds, and a period of 15 seconds.

5. A process according to any one of the preceding claims, characterised in that the pasteurised beverage is cooled to a temperature selected from the following temperatures: a temperature between 25° C. and 60° C., a temperature between 25° C. and 50° C., a temperature between 25° C. and 40° C., and a temperature of approximately 35° C.

6. A process according to any one of the preceding claims, characterised in that at least one of the components chosen from the container and its cap is sterilised by washing of this component with an effective amount of a sterilising solution.

7. A process according to claim 6, characterised in that at least one of the components chosen from the container and its cap is sterilised with a sterilising solution for a period selected from the following periods: a period of between 10 seconds and 1 minute, a period selected between 15 and 45 seconds, a period selected between 25 and 35 seconds, and a period of approximately 30 seconds.

8. A process according to either one of claims 6 and 7, characterised in that the sterilising solution contains peracetic acid.

9. A process according to claim 8, characterised in that the pH of the peracetic acid solution is adjusted to one of the following values: a value between approximately 2 and 4, a value between approximately 2 and 3, and a value of approximately 2.6.

10. A process according to either one of claims 8 and 9, characterised in that the peracetic acid is used at a concentration selected from the following concentrations: a concentration between 50 and 250 ppm, a concentration between 75 and 150 ppm, and a concentration of 100 ppm.

11. A process according to any one of the preceding claims, characterised in that at least one of the components chosen from the container and its cap is sterilised by treating this component with an effective amount of radiation.

12. A process according to claim 11, characterised in that the radiation is selected from the following radiations: ultraviolet radiation, ionising radiation, gamma radiation and beta particle radiation.

13. A process according to any one of the preceding claims, characterised in that the pasteurising step (f) is performed at a temperature selected from the following temperatures: a temperature between approximately 50° C. and 70° C., a temperature between approximately 55° C. and 65° C., and a temperature between approximately 60° C. and 65° C.

14. A process according to claim 13, characterised in that the pasteurising step (f) is performed for a period selected from the following periods: a period between approximately 15 to 60 minutes, a period between approximately 20 to 30 minutes, and a period of approximately 20 minutes.
